(19) United States
(12) Patent Application Publication
(10) Pub. No.: US 2025/0251770 A1
(43) Pub. Date: Aug. 7, 2025

(54) POWER-AWARE CONTROL PLANE

(71) Applicant: MELLANOX TECHNOLOGIES, LTD., Yokneam (IL)

(72) Inventors: Dean Itzhak Levi, Tel-Aviv (IL); Eyal Srebro, Kfar Yehoshua (IL); Tom Remen, Tel-Aviv (IL); Niv Aibester, Herzliya (IL)

(21) Appl. No.: 18/433,114

(22) Filed: Feb. 5, 2024

(51) Int. Cl. G06F 1/3209; H04L 45/74; H04L 69/22

(52) U.S. Cl. CPC G06F 1/3209; H04L 45/74; H04L 69/22

(57) ABSTRACT

An interconnect device is provided. In one example, an interconnect device includes ports and a control circuit capable of enabling and disabling control plane components based on received packets. Enabled control plane components enable the received packets to be forwarded to a destination via an egress port. Disabled control plane components enable a reduction in power consumption.

### FIELD OF THE DISCLOSURE

The present disclosure is generally directed toward networking and, in particular, toward networking devices and methods of operating the same.

### BACKGROUND

Switches and similar network devices represent a core component of many communication, security, and computing networks. Switches are often used to connect multiple devices, device types, networks, and network types.

Devices including but not limited to personal computers, servers, or other types of computing devices, may be interconnected using network devices such as switches. Such interconnected entities form a network that enables data communication and resource sharing among the nodes. While a particular switch may be capable of handling large amounts of data, often, switches do not operate at full capacity. As a result, conventional switches consume amounts of power which may be unnecessarily high during periods of low traffic.

### BRIEF SUMMARY

In accordance with one or more embodiments described herein, a computing system, such as an interconnect device, may enable a diverse range of systems, such as switches, servers, personal computers, and other computing devices, to communicate across a network. Such a computing system, which may be referred to herein as an interconnect device or switch, may implement one or more power-aware control plane optimization algorithms. Implementing a power-aware control plane may include processing received packets to identify control plane elements, such as random-access memory (RAM) circuits, application-specific integrated circuits (ASICs), and/or other components, which may be required to forwarding the packets. If such control plane elements are disabled, a power-aware control plane may be enabled to activate the control plane elements for use in forwarding the packets. Over time, when the power-aware control plane elements are not used for a period the control plane elements may be selectively disabled to conserve power. The systems and methods described herein may provide for reduced power consumption as compared to conventional systems and methods for forwarding packets. A power-aware operation of the control plane as described herein enables balancing power and performance. Systems and methods described herein support full packet processing capabilities while maintaining required components active when needed.

The present disclosure describes a system and method for enabling an interconnect device, such as a switch, or other computing system to reduce overall power consumption by offering a feature in which the interconnect device disables non-active control plane elements until needed for forwarding packets.

In an illustrative example, a system is disclosed that includes one or more circuits to: receive a packet via a port; identify, based on the packet, one or more circuits for processing the packet; in response to identifying the one or more circuits for processing the packet, apply power to the one or more circuits; and provide the packet to the one or more circuits.

In another example, a method is disclosed that includes receiving a packet via a port; identifying, based on the packet, one or more circuits for processing the packet; in response to identifying the one or more circuits for processing the packet, applying power to the one or more circuits; and providing the packet to the one or more circuits.

In yet another example, a switching device is disclosed that includes one or more circuits to: receive a packet via a port; identify, based on the packet, one or more circuits for processing the packet; in response to identifying the one or more circuits for processing the packet, apply power to the one or more circuits; and provide the packet to the one or more circuits.

Any of the above example aspects include any one or more of: wherein each of the one or more circuits comprises hardware to perform a logic algorithm associated with forwarding the packet; wherein identifying the one or more circuits for processing the packet comprises identifying one or more services required for processing the packet based on a header of the packet; wherein the one or more circuits for processing the packet are identified based at least in part on a flow associated with the packet; wherein the one or more circuits include a first circuit associated with ingress packet processing and a second circuit associated with egress packet processing; wherein the one or more circuits are associated with ingress packet processing; wherein processing the packet comprises performing ingress processing; wherein the one or more circuits comprise one or more of a random-access memory (RAM) circuit, an application specific integrated circuit (ASIC), a field programmable gate array (FPGA), flash memory, network interface card (NIC), content addressable memory (CAM), port logic circuit, serializer/deserializer (SerDes) circuit, and a clock tree circuit; wherein the circuits comprise a subset of the RAM; wherein the one or more circuits are associated with egress packet processing; and wherein the one or more circuits comprise one or more of a random-access memory (RAM) circuit, an application specific integrated circuit (ASIC), a field programmable gate array (FPGA), flash memory, network interface card (NIC), content addressable memory (CAM), port logic circuit, serializer/deserializer (SerDes) circuit, and clock tree circuit.

Any of the above example aspects may further include determining a first circuit of the one or more circuits is inactive over a predetermined amount of time, and in response to determining the first circuit of the one or more circuits is inactive over the predetermined amount of time, disabling the first circuit.

Any of the above example aspects may further include identifying, based on the packet, a second one or more circuits associated with egress processing for processing the packet, enabling the second one or more circuits associated with egress processing, and performing egress processing of the packet with the second one or more circuits associated with egress processing.

Additional features and advantages are described herein and will be apparent from the following Detailed Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a network in accordance with at least some embodiments of the present disclosure;

FIG. 2 is a block diagram depicting an illustrative configuration of an interconnect device in accordance with at least some embodiments of the present disclosure;

FIGS. 3-5 are block diagrams depicting illustrative configurations of routing circuitry of an interconnect device in accordance with at least some embodiments of the present disclosure;

FIG. 6 is a flowchart depicting an illustrative configuration of a method in accordance with at least some embodiments of the present disclosure; and

FIG. 7 is a flowchart depicting an illustrative configuration of a method in accordance with at least some embodiments of the present disclosure.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

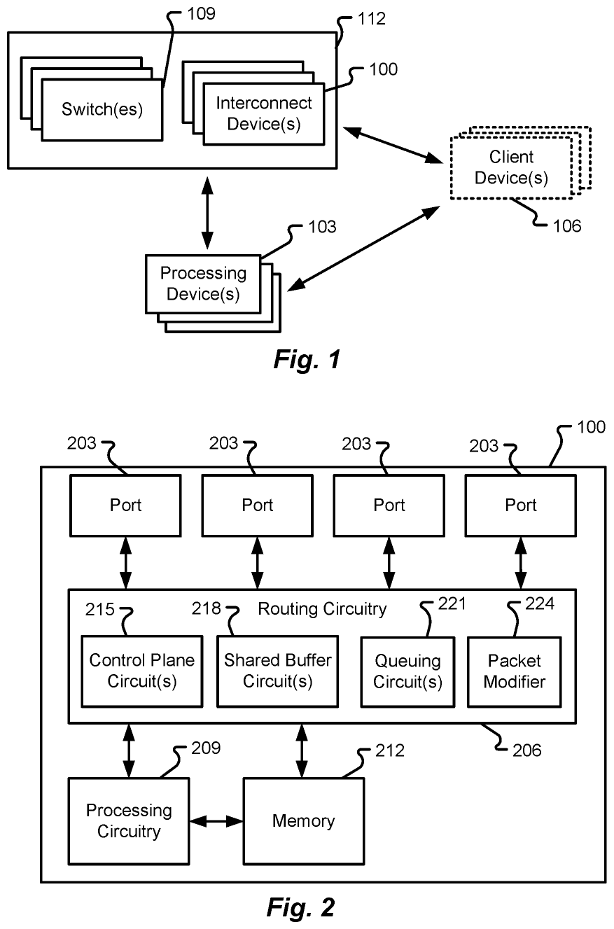

Referring now to FIGS. 1-6, various systems and methods for implementing a power profile in an interconnect device will be described. The concepts of power-aware control planes depicted and described herein can be applied to any type of computing system capable of receiving and/or transmitting data, whether the computing system includes one port or a plurality of ports. Such a computing system may be a switch, but it should be appreciated any type of computing system may be used. The ability of interconnect devices, such as switches, to traverse data is constantly increasing, forwarding packet-processing is becoming more complex as a result power-requirements, and power-density of interconnect devices is increasing. As such, the need for power-efficient interconnect devices is growing. The systems and methods described herein may be used to reduce overall power consumption for interconnect devices.

As illustrated in FIG. 1, a computing environment as described herein may be a network of processing devices 103 interconnected by a fabric 112. A fabric 112 as described herein may include one or more interconnect devices 100 and/or one or more switches 109. One or more interconnect devices 100 and/or switches 109 may be in communication with one or more processing devices 103. The network of processing devices 103 and the fabric 112 may be in communication with one or more client devices 106. Such a network of processing devices 103 and fabric 112 of interconnect devices 100 and/or switches 109 may be useful in various settings, from data centers and cloud computing infrastructures to artificial intelligence systems.

Processing devices 103 may be computing units, such as personal computers, servers, or other computing devices, and may be responsible for executing applications and performing data processing tasks. Processing devices 103 as described herein can range from servers in a data center to desktop computers in a network, or to devices such as internet of things (IoT) sensors and smart devices.

Each processing device 103 may include one or more processing circuits, such as Graphics Processing Units (GPUs), central processing units (CPUs), application-specific integrated circuits (ASICs), field programmable gate arrays (FPGAs), or other circuitry capable of performing computations, as well as memory and storage resources to run software applications, handle data processing, and perform specific tasks as required. In some implementations, processing devices 103 may also or alternatively include hardware such as GPUs for handling intensive tasks for machine learning, artificial intelligence (AI) workloads, or other complex processes.

For example, processing devices 103 may operate as a high-performance computing (HPC) cluster. A cluster of processing devices 103 may comprise numerous interconnected servers, each equipped with powerful CPUs and/or GPUs. The processing devices 103 may provide computational horsepower for, as an example, training large-scale AI models or running complex scientific simulations. For AI and machine learning tasks, the processing devices 103 may comprise one or more GPUs or other processing circuitry which may be capable of handling parallel processing requirements of neural networks and other applications.

Interconnect devices 100 and switches 109, as described in greater detail herein, may enable communication between processing devices 103 and/or client devices 109. An interconnect device 100 may be, for example, a switch, a network interface controller (NIC), or other device capable of receiving and sending data, and may act as a central node in the network. Interconnect devices 100 may be wired in a topology including spine switches and top-of-rack (TOR) switches for example. Interconnect devices 100 and switches 109 may be capable of receiving, processing, and forwarding data, e.g., packets, to appropriate destinations within the network, such as processing devices 103 and/or client devices 109. In some implementations, an interconnect device 100 or a switch 109 as described herein may be included in a switch box, a platform, or a case which may contain one or more interconnect devices 100 and switches 109 as well as one or more power supply devices 106. While the description provided herein describes the use of an interconnect device 100, it should be appreciated the systems and methods described herein may be applicable to the use of switches 109 and interconnect devices 100.

In some implementations, each processing device 103 may be connected to one or more ports of one or more interconnect devices 100 via network cables or wirelessly. Processes, such as applications, executed by processing devices 103 may involve transmitting data to nodes of the network, such as to other processing devices 103 and/or to client devices 109. Data may flow through the network of processing devices 103 and interconnect devices 100 using one or more protocols such as transmission control protocol (TCP), user datagram protocol (UDP), or Internet protocol (IP), for example. Each interconnect device 100 may, upon receiving data from a processing device 103 or another interconnect device 100, examine the data to identify a destination for the data and route the data through the network.

Client devices 106 as described herein may be computing devices which, for example, engage in AI-related, research-related, and other processor-intensive tasks, and utilize processing devices 103 to handle the computational loads and data throughput required by such intensive applications. Client devices 106 may include, for example, workstations and personal computers used by researchers, data scientists, and professionals for developing, testing, and running AI models and research simulations. Client devices 106 may include one or more CPUs and/or GPUs but may require additional computational power for complex tasks.

By interacting with processing devices 103, client devices 106 may be enabled to perform functions such as training machine learning models, performing data processing, running simulations, analyzing large datasets, and performing complex data processing tasks, such as data mining, pattern recognition, and predictive modeling, for examples.

An interconnect device 100 as described herein may in some implementations be as illustrated in FIG. 2. Such an interconnect device 100 may include a plurality of ports 203, routing circuitry 206, processing circuitry 209, and memory 212.

The ports 203 of an interconnect device 100 may be capable of facilitating the transmission of data packets, or non-packetized data, into, out of, and through the interconnect device 100. Such ports 203 may serve as interface points where network cables may be connected, connecting the interconnect device 100 with other interconnect devices 100, processing devices 103, and/or client devices 106.

Each port 203 may be capable of receiving incoming data packets from other devices and/or transmitting outgoing data packets to other devices. In some implementations, ports 203 may be configured to operate as either dedicated ingress or egress ports 203 or may be enabled to operate in a dual functionality capable of performing ingress and egress functions. For example, an egress port 203 may be used exclusively for sending data from the interconnect device and an ingress port 203 may be used solely for receiving incoming data into the switch.

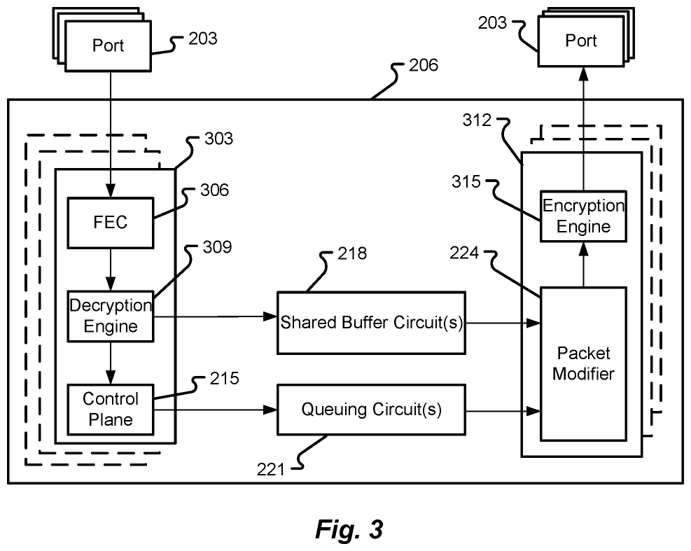

Routing circuitry 206 of an interconnect device 100, as described in greater detail below and in relation to FIG. 3, may be capable of handling a received packet by determining a port from which to send the packet and forwarding the packet from the determined port. Using a system or method as described herein, routing circuitry 206 may be capable of throttling the traversal of data through an interconnect device 100 based on one or more power profiles. As a result, the routing circuitry 206 may be capable of reducing an overall amount of power consumed by the interconnect device 100 without incurring a penalty in processing power.

In support of the functionality of the routing circuitry 206, processing circuitry 209 may be configured to control aspects of the routing circuitry 206 to accomplish throttling in relation to power profiles. The processing circuitry 209 may in some implementations include a CPU, an ASIC, and/or other processing circuitry which may be capable of handling computations, decision-making, and management functions required for operation of the interconnect device 100.

Processing circuitry 209 may be configured to handle level management and control functions of the interconnect device 100, such as setting up routing tables, configuring ports, and otherwise managing operation of the interconnect device 100. Processing circuitry 209 may execute software and/or firmware to configure and manage the interconnect device 100, such as an operating system and management tools.

Processing circuitry 209 may include one or more circuits and components such as control plane circuits 215, shared buffer circuits 218, queuing circuits 221, packet modifier circuits 224, and/or other circuits and components which may be used to process and forward packets received by the interconnect device 100. Each of these examples and others may be as described in greater detail below and may be capable of being selectively enabled and disabled, in whole or in part, based on packets received by the interconnect device 100.

Memory 212 of an interconnect device 100 as described herein may comprise one or more memory elements capable of storing configuration settings, application data, operating system data, and other data. Such memory elements may include, for example, random access memory (RAM), dynamic RAM (DRAM), flash memory, non-volatile RAM (NVRAM), ternary content-addressable memory (TCAM), static RAM (SRAM), and/or memory elements of other formats.

FIG. 3 illustrates elements of routing circuitry 206 of an interconnect device 100 in accordance with one or more implementations of the present disclosure. One or more ingress ports 203 may, upon receiving data, transmit the data to one or more ingress processing circuits 303. In some implementations, each ingress port 203 may be associated with a dedicated ingress processing circuit 303, while in other implementations, multiple ingress ports 203 may share an ingress processing circuit 303.

Each ingress processing circuit 303 may include one or more of a forward error correction (FEC) circuit 306, a decryption engine circuit 309, a control plane 215, and/or other circuits and components which may handle ingress packets and non-packetized ingress data. An FEC circuit 306 as described herein may be used to perform error detection and correction for packets received from a port 203 before the packets are directed to an egress port. The FEC circuit 306 may receive ingress data from a port 203 and, after performing FEC, output the received ingress data or a processed version of the ingress data to a decryption engine circuit 309.

A decryption engine circuit 309 as described herein may be used to decrypt all or a portion of received packets to enable the interconnect device 100 to determine a port 203 from which to send each packet. The decryption engine circuit 309 may be capable of ensuring that sensitive data remains protected from unauthorized access during traversal of the data through the interconnect device 100. The decryption engine circuit 309 may output received packets or data associated with received packets to one or more shared buffer circuits 318 as described below. The decryption engine circuit 309 may also output data associated with received packets to the control plane 312.

A control plane 312 as described herein may be used to manage how received data packets are forwarded and handled within the interconnect device 100. The control plane 312 may receive data associated with a received packet from the decryption engine circuit 309 and, based on the data associated with received packet, write instructions to one or more queueing circuits 321 as described below.

A control plane 312 may include one or more components such as one or more RAM circuits, ASICs, FPGAs, flash memory, network interface cards (NICs), content addressable memory (CAM) circuits, port logic circuits, serializer/deserializer (SerDes) circuits, and clock tree circuits, for example. Each component of the control plane 312 may be capable of being selectively enabled and/or disabled based on packets received by the interconnect device 100. The control plane 312 may be referred to herein as an ingress control plane. Different packets handled by the interconnect device 100 may require a different set or subset of components of the control plane 312 to be forwarded. As described herein, a controller or control circuit may be used which determines which components are required for a received packet and ensures the required components are enabled.

Each of the FEC circuit 306, decryption engine circuit 309, control plane 215, and/or other circuits and components of the ingress processing circuits 303 may include one or more of an ASIC, FPGA, digital signal processor (DSP), network processor, accelerator, hardware secure module, CPU, and/or other components and circuits capable of performing ingress processing. As should be appreciated, each ingress processing circuit 303 of an interconnect device 100 may include one or more additional circuits and components in addition to or instead of the FEC circuit 306, decryption engine circuit 309, and control plane 215 described above.

Each of the ingress processing circuits 303 of the interconnect device 100 may be enabled to write data to a shared-buffer circuit 218 and a queueing circuit 221. Packets to be egressed from the interconnect device 100 may be stored in the shared-buffer circuit 218. Data which may be used by egress processing circuits 312 to route packets to egress ports 203 may be written to the queuing circuits 221. Once the queueing circuit 221 assigns a particular packet to a particular egress port 203, packet data stored in the shared buffer circuit 218 may be read by an egress processing circuit 312 associated with the particular egress port 203.

Data to be sent from the interconnect device 100 may be processed by one or more egress processing circuits 312. In some implementations, each port 203 used for egress may be associated with a dedicated egress processing circuit 312. In other implementations, multiple egress ports 203 may share one or more egress processing circuits 312.

An egress processing circuit 312 may include, but should not be considered as limited to, a packet modifier 224 and an encryption engine 315. A packet modifier 224 as described herein may include circuitry such as one or more RAM circuits, ASICs, FPGAs, flash memory, network interface cards (NICs), content addressable memory (CAM) circuits, port logic circuits, serializer/deserializer (SerDes) circuits, and clock tree circuits, or other componentry capable of adjusting packets before the packets are transmitted from the interconnect device. Such adjustments may include, for example, the adding or removal of tags, modification of settings and packet header data, and other modifications.

Each component of the packet modifier 224 may be capable of being selectively enabled and/or disabled based on packets received by the interconnect device 100. The packet modifier 224 may be referred to herein as an egress control plane. Different packets handled by the interconnect device 100 may require a different set or subset of components of the packet modifier 224 to be forwarded. As described herein, a controller or control circuit may be used which determines which components are required for a received packet and ensures the required components are enabled.

An encryption engine 333 as described herein may include circuitry such as an ASIC, an FPGA, or other componentry capable of encrypting packets before the packets are transmitted from the interconnect device. Such encryption may include, for example, use of encryption algorithms such as Advanced Encryption Standard (AES), RSA, or other algorithms.

After being processed by an egress processing circuit 312, a packet may be transmitted from the interconnect device 100 via an egress port 203. The egress port 203 may be directly connected to an ultimate destination of the packet or may be connected to another interconnect device 100 which may forward the packet towards the ultimate destination.

As described above, routing circuitry 206 of an interconnect device 100 may be capable of enabling and disabling components of a control plane 215 and a packet modifier 224 based on the packets being handled by the interconnect device 100. As a result, the routing circuitry 206 may be capable of reducing an overall amount of power consumed by the interconnect device 100 without incurring a penalty in processing power.

The reduction of the overall power consumption of the interconnect device 100 may be achieved through the use of one or more control circuits. A control circuit as described herein may be one or more of, or a combination of, ASICs, FPGAs, and other componentry capable of performing the functions of the control circuit as described herein. In some implementations, each of the control plane 215 and the packet modifier 224 may include a separate control circuit capable of enabling and disabling components based on received packets. In other implementations, one control circuit external to one or both of the control plane 215 and the packet modifier 224 may be enabled to enable and disable components of each of the control plane 215 and the packet modifier 224.

A control circuit as described herein may be capable of processing data traversing the interconnect device 100, determining components necessary for ingress and/or egress processing of the data, and enabling the components necessary.

The interconnect device 100, using a control plane 215 and/or a packet modifier 224 which are capable of enabling and disabling components based on the packets received via a port 2013, may be enabled to operate at a reduced power consumption level as compared to conventional interconnect devices 100 which do not disable components of control planes 215 and/or packet modifiers 224.

When a packet is received via a port 203, the packet is handled by an ingress processing circuit 303.

As described above, an ingress processing circuit 303 may include FEC circuit, a decryption engine circuit, a control plane 312, and/or other circuits and components which may handle ingress packets. In some implementations, each ingress port 203 may be associated with a dedicated ingress processing circuit 303, while in other implementations, multiple ingress ports 203 may share an ingress processing circuit 303.

The control plane 215 may be a set of components responsible for processing received packets and making decisions about where and how the packets are sent. The control plane 215 may serve as a logical layer that handles routing and switching decisions. The control plane 215 may be responsible for maintaining routing tables and making decisions about packet forwarding based on routing tables and information in each received packet.

The control plane 215 may be configured to receive a packet, process the packet to determine a forwarding decision, and to forward the packet by storing the packet in one or more buffer circuits 218 and by writing data to one or more queuing circuits 221.

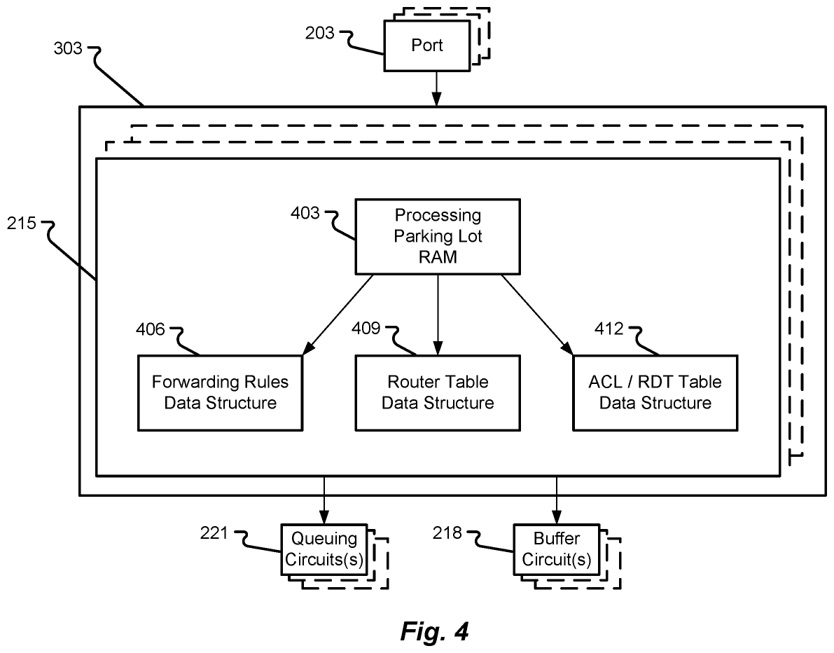

To determine the forwarding decision, the control plane 215 may utilize one or more components and/or data structures. As illustrated in FIG. 4, a control plane 215 may include a number of such components and/or data structures. Components may include, for example, a random-access memory (RAM) circuit, an application specific integrated circuit (ASIC), a field programmable gate array (FPGA), flash memory, network interface card (NIC), content addressable memory (CAM), port logic circuit, serializer/deserializer (SerDes) circuit, and clock tree circuit. Data structures of a control plane 215 may include RAM and/or other circuitry and hardware. Example data structures include, but should not be considered as being limited to, one or more forwarding rule data structures 406, router table data structures 409, and access control list (ACL)/rule decision table (RDT) table data structures 412.

RAM in a control plane 215 may serve as a temporary storage area for data being processed. RAM may hold data such as configuration tables and packets waiting for processing or transmission. RAM may enable the control plane 215 to quickly retrieve and update information for maintaining packet routing and management operations.

A RAM circuit of a control plane 215 may perform as a processing parking lot RAM 403. A processing parking lot RAM 403 may be used for temporarily storing data packets, or portions of data packets, before the data packets are processed and/or forwarded.

ASICs in a control plane 215 may be designed to execute specific networking tasks. Such tasks may include high-speed data processing tasks, such as packet forwarding and routing. FPGAs in a control plane 215 may be used for packet processing, network traffic analysis, and implementing custom logic functions relating to packet forwarding and/or processing. Flash memory in a control plane 215 may provide storage for firmware, boot code, and system configuration settings, for example. A NIC in a control plane 215 may interface with one or more networks. The NIC may facilitate communication between the control plane 215 and network devices. CAM of a control plane 215 may be used for data searching, such as for locating specific information in a database, for example MAC addresses in a MAC address table. Port logic circuit of a control plane 215 may manage the functionalities of one or more physical ports. Port logic circuits may control port activities such as transmission, reception, error detection, and handling port status (up/down). Port logic circuits may also manage the flow of data in and out of the control plane 215, handling tasks like frame encapsulation/decapsulation and managing link aggregation. A SerDes circuit of a control plane 215 may be used to convert data between serial and parallel forms. A clock tree circuit may distribute a clock signal throughout the control plane, ensuring synchronized operation of all components.

Forwarding rule data structures 406 may be used by a control plane 215 to determine how to forward packets through the network. Such rules may be based on headers of received packets, such as IP addresses, port numbers, and protocol types. A forwarding rule data structure 406 may contain information such as destination IP address ranges, corresponding output ports, or next-hop addresses.

Router table data structures 409 may store router tables to be used by a control plane 215 to store routes to various network destinations. A router table may include a number of entries. Each entry may contain a destination network address, a cost or distance to that network address, the next-hop address, and the interface through which the packet should be sent.

ACL/RDT (Access Control List/Rule Decision Table) Table Data Structures 412 may be used by a control plane 215 for security purposes in routers and switches. ACL/RDT table data structures 412 may define rules that restrict or permit the flow of traffic based on criteria such as IP addresses, port numbers, and protocol types. An ACL and/or an RDT entry may for example include a set of conditions and an action (e.g., permit or deny) to be taken when those conditions are met.

When a packet arrives at the control plane 215, the packet may be first stored in the parking lot RAM 403. The control plane 215 may then examine the packet's header, consult a routing table, and determine the best route for the packet. Depending on the switch's architecture and/or the type or protocol of the packet being processed, additional processing such as Quality of Service (QOS) analysis, security checks, or VLAN tagging may also be performed while the packet is in the RAM. Once the necessary processing is complete, the packet is forwarded from the RAM to the appropriate egress port for transmission to its next destination.

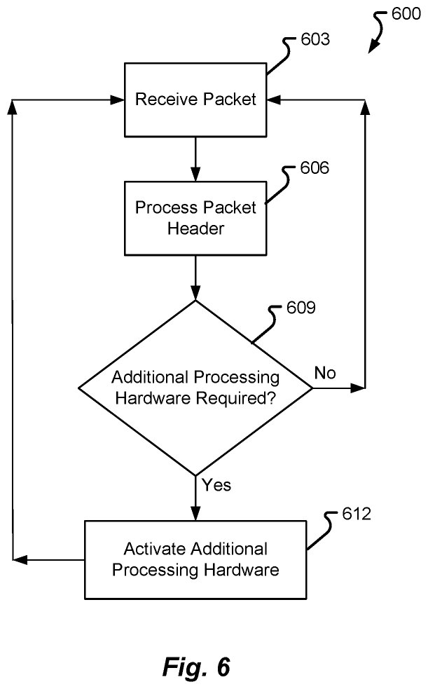

A control circuit, such as processing circuitry 209, an ASIC, an FPGA, or another circuit capable of processing packets, determining which components and/or data structures are required for making a forwarding decision relating to the packet, and enabling or instructing another component to enable the required components and/or data structures may be enabled to enable and disable each of the components and/or data structures by executing a method 600 as described below in relation to FIG. 6.

The control circuit may be comprised by or in communication with the control plane 215. In some implementations, each port 203 may be associated with a different control plane 215 and each control plane 215 may be associated with the same or different control circuits.

The control circuit may be enabled to enable or disable each component or data structure in whole or in part. For example, the control circuit may be enabled to enable RAM containing specific memory cells which may be required to forward a particular packet.

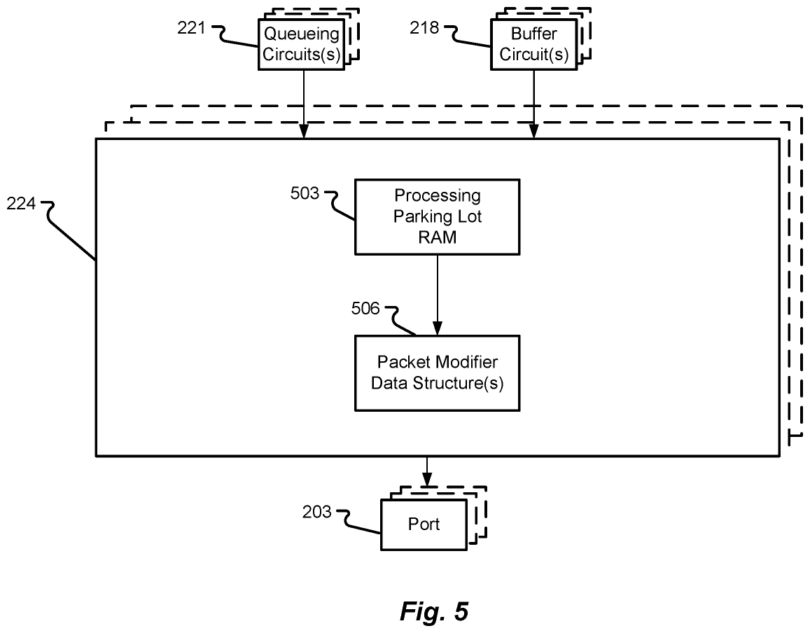

The same or another control circuit may also be enabled to enable and/or disable components and/or data structures relating to egress processing, such as illustrated in FIG. 5. As illustrated in FIG. 5, a packet modifier circuit 224 may be enabled to receive instructions via one or more queueing circuits 221 and to forward packets from one or more buffer circuits 218 to an egress port 203.

A packet modifier circuit 224, when forwarding a packet, may be responsible for performing a variety of features, such as packet modifier data structures 506. Similar to the control plane 215 described above, the packet modifier circuit 224 may utilize one or more components and/or data structures. For example, a packet modifier circuit 224 may include one or more of a random-access memory (RAM) circuit, an application specific integrated circuit (ASIC), a field programmable gate array (FPGA), flash memory, network interface card (NIC), content addressable memory (CAM), port logic circuit, serializer/deserializer (SerDes) circuit, and clock tree circuit. Data structures of a control plane 215 may include RAM and/or other circuitry and hardware. Example data structures include, but should not be considered as being limited to, one or more forwarding rule data structures 406, router table data structures 409, and access control list (ACL)/rule decision table (RDT) table data structures 412.

Similar to the control plane 215 described above which performs ingress processing, a packet modifier circuit 224 may also comprise a processing parking lot RAM 503 which may store data of packets being processed by the packet modifier circuit 224 until the packet is ready to be transmitted from a port 203.

A control circuit managing the enabling and/or disabling of components of one or both of a control plane 215 and a packet modifier circuit 224 may be enabled to perform a method 600 as illustrated in FIG. 6 and as described below.

As described above, the method 600 of FIG. 6 may be performed by a control plane of either an ingress processing circuit or an egress processing circuit. In some implementations, the method 600 may be performed by one or more circuits. Such circuits may include, for example, an ASIC or other processing device capable of performing the described actions.

The method 600 may be implemented by an interconnect device 100 or a switch 109 as described herein to enable power consumption control based on processing requirements for the particular packets being received and forwarded by the device 100. As described above, an interconnect device 100 may be, for example, a switch or other type of computing system capable of receiving and forwarding data in a network. The interconnect device 100 may be utilized by one or more processing devices 103 and/or client devices 109 to provide interconnect services with one or more other processing devices 103 and/or client devices 109.

At 603, the control plane 215 may receive a packet or a portion of a packet. The packet may first be received by an interconnect device 100 or a processing device 103 which comprises the control plane 215.

Upon packet data, such as a complete packet or a packet header, being received by a control plane 215, the packet data may be stored in a parking lot RAM element.

From the parking lot RAM, the packet data may be distributed to one or more elements, such as a forwarding rules cache, a router table RAM, an ACL/RDT table RAM, and/or other components and data structures. A copy of the packet data may remain in the parking lot RAM element until any operations, such as processing of the packet data, being performed by the control plane 215 is complete. Once the operations are complete, the packet data may move from the parking lot RAM to the egress side.

Upon receiving the packet, the device may perform some ingress processing, such as FEC and decryption as illustrated in FIG. 3. In some implementations, the header of the packet may be extracted and input to the control plane 215.

In some implementations, the method 600 may be performed by an egress processing circuit or packet modifier circuit 224. In such an implementation, the packet modifier circuit 224 may receive the packet or a portion of the packet via one or more queueing circuits 221 and/or buffer circuits 218.

When a packet is received by a packet processing engine such as a control plane 215, it may not be evident as to what type of flow-based forwarding decisions the packet will require. For example, when a packet is received by a control plane 215, an ACL may perform some action, and that action may cause another action to be performed. By enabling only the necessary features of the control plane 215 when required by a packet, the control plane 215 can learn which entries in data structures and/or which components are being used in a window of time. Once a component or data structure entry is enabled, the component or data structure entry may remain enabled until the component or data structure entry is unused for a particular amount of time. In this way, the control plane 215 can keep the necessary components or entries in designated RAM or cache active and keep the main data structure inactive and keep the associated processing pipe with data processing structure inactive.

To enable this feature, at 606, the control plane 215 may process a header of the packet. In some implementations, processing a header of a packet may comprise processing the header with a hardware mechanism capable of identifying what rules and/or engines may be needed to determine a forwarding decision for the packet. Based on the rules and/or engines needed, the hardware mechanism may enable any necessary data structures and/or components. While described herein as a hardware mechanism or control circuit, it should be appreciated that the same or similar systems and methods may be implemented using firmware or a software application.

When a packet is received, a parser may be used to extract the packet header. Based on the packet header, the control plane 215 may be configured to understand what type of lookup is necessary. This determination may be made for each packet traversing the control plane and may occur on both the ingress and the egress control planes.

By processing the packet or portion of the packet, the control plane 215 may be capable of identifying, based on the packet, one or more circuits for processing the packet. As an example, the one or more circuits for processing the packet may be identified based at least in part on a flow associated with the packet. As another example, identifying the one or more circuits for processing the packet comprises identifying one or more services required for processing the packet based on a header of the packet.

The identified circuits may comprise hardware to perform a logic algorithm associated with forwarding the packet. Such hardware may include, for example, one or more RAM circuits, ASICs, FPGAs, flash memory, NICs, CAM circuits, port logic circuits, SerDes circuits, and/or clock tree circuits.

As described above, the method 600 may be performed on one or both of an ingress side and an egress side. The identified circuits may thus include circuits associated with ingress packet processing as well as circuits associated with egress packet processing.

In some implementations, steps of the method 600 may be performed twice, once for the ingress side and once for the egress side. For example, a first set of circuits associated with ingress processing may be identified based on the packet, then a second set of circuits associated with egress processing may be identified based on the packet.

As described above, a control plane 215 may be dedicated to one or more ports. In some implementations, a single control plane 215 may be associated with one port or a group of ports (e.g., 8-10 ports per group). Each control plane 215 may be associated with a different set of hardware devices.

Each hardware device may be associated with one or more services. Devices may include, for example, a forwarding rules cache, a router table, an ACL table, an RDT, etc. Devices may also be related to services such as the changing of an IP, encapsulating the packet in a wrapper, etc.

At 609, the control plane may determine whether additional processing hardware is required. Determining whether additional processing hardware is required may involve comparing a list of requirements based on the received packet with a list of enabled components. If any components required are not currently enabled, the control plane may determine the components should be enabled. If no additional processing hardware is required, the method 600 may return to 603 and the control plane may wait for a next packet. In some implementations, the control plane may keep a list of currently enabled or active hardware.

In some implementations, the control plane may keep a list of types of packets which the control plane may use to determine whether additional processing hardware is required. For example, the control plane 215 may compare received packet headers to the list to check if any required hardware is disabled.

In some implementations, a separate algorithm for each service may be used. For example, a packet header may be processed separately by a plurality of algorithms, wherein each algorithm is associated with a different set of hardware.

As described above, in some implementations, The determination for the egress hardware may occur later, after the packet is routed to a buffer and assigned to an egress port.

In some implementations, determining whether additional processing hardware is required may comprise determining an amount of a particular component or data structure which is required for processing a packet and determining whether the amount is enabled. The amount of a particular component or data structure which is required for processing a packet may depend, for example, on a rate at which packets are received by a control plane.

The control plane may be capable of enabling a subset of RAM such that only necessary portions, as opposed to entire data structures, may be required to be enabled. For example, in a router table there may be 8k entries and 20k entries. If a flow is received which requires 8k entries and does not require 20k entries, then only the 8k entries may be enabled. By enabling only a subset of RAM, a reduction in power consumption may be achieved.

As an example, a forwarding rules cache of a control plane 215 may be required to support a large variety of different flows. At any given time, only a small portion of the cache may be in use. For this reason, it may not be necessary to constantly have the entire cache active. Only a small subset of the cache may be necessary to be enabled at any given time. Other or larger portion of the cache may be enabled when needed. By doing so, power savings may be achieved by avoiding the consumption of power associated with keeping the entire cache active. Furthermore, in addition to the RAMs storing the cache, logic engines associated with the data structure may also be enabled only when needed. In addition to or instead of the forwarding rules cache, the same process of enabling the portion necessary for any given packet may be applied to a router table, ACL, or any type of cache relating to packet processing. When not enabled, data structures and components may be kept in a low-power mode.

At 612, based on the identification of the circuits required for processing the packet, if additional processing hardware is required, the control plane may activate the additional processing hardware by applying power to the processing hardware. Activating the additional processing hardware may enable the ingress and/or egress processing of the packet. In some implementations, activating additional processing hardware may include applying power to a specific logic area and/or one or more cells of memory or units of RAM. In some implementations, activating additional processing hardware may include enabling a clock or increasing a frequency of a clock for a logic area and/or one or more cells of memory or units of RAM. By enabling a clock or increasing a frequency of a clock for a logic area and/or one or more cells of memory or units of RAM, the processing hardware may be enabled to support a required packet rate.

After activating the additional processing hardware, the control plane may perform the ingress (or egress) processing using the processing hardware by providing the packet, or packet data, to the processing hardware. The processing hardware may next perform forwarding decisions, implement, or perform services, or otherwise process the packet as part of the packet forwarding process. After processing, the packet may eventually be transmitted from an egress port.

In some implementations, a control plane 215 may also be capable of deactivating or disabling hardware components and/or data structures when the hardware (or data structure) is not used for some time. To accomplish this feature, the control plane 215 may in some implementations use a combination of timing mechanisms and control logic. The control plane 215 may, upon enabling a hardware component or data structure, initiate a timing mechanism. For example, the control plane 215, upon enabling a hardware component or data structure, may trigger or reset a timer. The timer may be set to a predefined duration, such as one second. The timer may count down from the predefined duration.

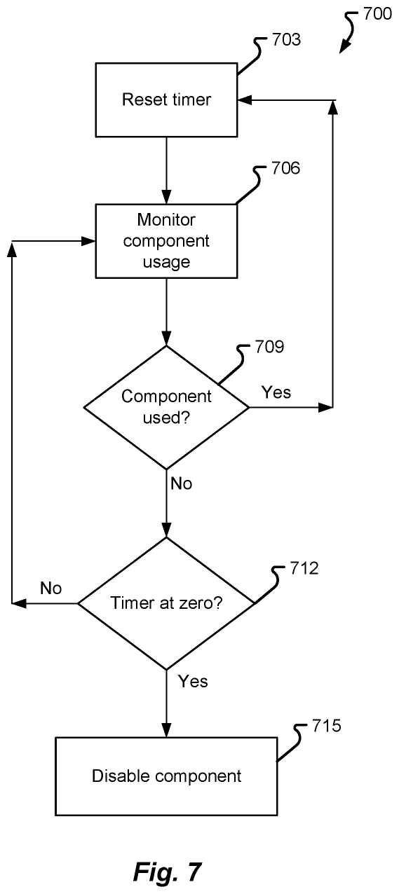

As illustrated in FIG. 7, a method 700 of deactivating or disabling hardware components may begin when one or more hardware components or circuits are enabled, such as through a method 600 as described above. At 703, when a hardware component or data structure is enabled, a timer associated with the hardware component or data structure may be reset to a predefined duration, such as one second for example.

At 706, usage of the hardware component or data structure may be monitored. Such monitoring may be performed in a similar manner as in the processing of packet headers 606 described above in relation to FIG. 6 to determine whether additional processing hardware is required. At 709, a determination may be made as to whether a hardware component or data structure is used. If a hardware component or data structure is used, the timer may reset to the predefined duration at 703 and the method 700 may repeat. If a timer for a hardware component or data structure reaches zero at 712, the hardware component or data structure may be disabled or deactivated at 715. If the timer has not yet reached zero at 712, the method 700 may involve continuing to monitor usage of the hardware component or data structure at 706. If at any point during the countdown the component becomes active again, the mechanism may reset the timer, preventing the hardware from being disabled prematurely. As should be appreciated, in some implementations instead of counting down from a predefined duration to zero, the timer may be a clock which counts up from zero to a predefined duration. As should also be appreciated, a control plane 215 may keep a minimum amount of hardware active at all times to sustain a minimum performance level at any given time.

By using a logic circuit to deactivate unused hardware components and/or data structures, a reduction in power consumption can be achieved. By intelligently managing hardware components based on their usage as described herein, unnecessary power consumption can be reduced while maintaining system responsiveness.

The present disclosure encompasses methods with fewer than all of the steps identified in FIG. 6 (and the corresponding description of the method 600), as well as methods that include additional steps beyond those identified in FIG. 6 (and the corresponding description of the method 600). The present disclosure also encompasses methods that comprise one or more steps from the methods described herein, and one or more steps from any other method described herein.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art. It is to be appreciated that any feature described herein can be claimed in combination with any other feature(s) as described herein, regardless of whether the features come from the same described embodiment.

What is claimed is:

1. A system comprising one or more circuits to:
receive a packet via a port;
identify, based on the packet, one or more circuits for processing the packet;
in response to identifying the one or more circuits for processing the packet, apply power to the one or more circuits; and
provide the packet to the one or more circuits.

2. The system of claim 1, wherein each of the one or more circuits comprises hardware to perform a logic algorithm associated with forwarding the packet.

3. The system of claim 1, wherein the one or more circuits are further to:
determine a first circuit of the one or more circuits is inactive over a predetermined amount of time; and
in response to determining the first circuit of the one or more circuits is inactive over the predetermined amount of time, disabling the first circuit.

4. The system of claim 1, wherein identifying the one or more circuits for processing the packet comprises identifying one or more services required for processing the packet based on a header of the packet.

5. The system of claim 1, wherein the one or more circuits for processing the packet are identified based at least in part on a flow associated with the packet.

6. The system of claim 1, wherein the one or more circuits include a first circuit associated with ingress packet processing and a second circuit associated with egress packet processing.

7. The system of claim 1, wherein the one or more circuits are associated with ingress packet processing, and wherein processing the packet comprises performing ingress processing.

8. The system of claim 7, wherein the one or more circuits are further to:
identify, based on the packet, a second one or more circuits associated with egress processing for processing the packet;
enable the second one or more circuits associated with egress processing; and
perform egress processing of the packet with the second one or more circuits associated with egress processing.

9. The system of claim 8, wherein the one or more circuits comprise one or more of a random-access memory (RAM) circuit, an application specific integrated circuit (ASIC), a field programmable gate array (FPGA), flash memory, network interface card (NIC), content addressable memory (CAM), port logic circuit, serializer/deserializer (SerDes) circuit, and clock tree circuit.

10. The system of claim 9, wherein the one or more circuits comprise a subset of the RAM.

11. The system of claim 1, wherein the one or more circuits are associated with egress packet processing.

12. The system of claim 11, wherein the one or more circuits comprise one or more of a random-access memory (RAM) circuit, an application specific integrated circuit (ASIC), a field programmable gate array (FPGA), flash memory, network interface card (NIC), content addressable memory (CAM), port logic circuit, serializer/deserializer (SerDes) circuit, and clock tree circuit.

13. A switching device comprising one or more circuits to:
receive a packet via a port;
identify, based on the packet, one or more circuits for processing the packet;
in response to identifying the one or more circuits for processing the packet, apply power to the one or more circuits; and
provide the packet to the one or more circuits.

14. The switching device of claim 13, wherein the one or more circuits are further to:
determine a first circuit of the one or more circuits is inactive over a predetermined amount of time; and
in response to determining the first circuit of the one or more circuits is inactive over the predetermined amount of time, disabling the first circuit.

15. The switching device of claim 13, wherein identifying the one or more circuits for processing the packet comprises identifying one or more services required for processing the packet based on a header of the packet.

16. The switching device of claim 13, wherein the one or more circuits for processing the packet are identified based at least in part on a flow associated with the packet.

17. The switching device of claim 13, wherein the one or more circuits include a first circuit associated with ingress packet processing and a second circuit associated with egress packet processing.

18. The switching device of claim 13, wherein the one or more circuits are associated with ingress packet processing, and wherein processing the packet comprises performing ingress processing.

19. The switching device of claim 18, wherein the one or more circuits are further to:
identify, based on the packet, a second one or more circuits associated with egress processing for processing the packet;
enable the second one or more circuits associated with egress processing; and
perform egress processing of the packet with the second one or more circuits associated with egress processing.

20. A method comprising:
receiving a packet via a port;
identifying, based on the packet, one or more circuits for processing the packet;
in response to identifying the one or more circuits for processing the packet, applying power to the one or more circuits; and
providing the packet to the one or more circuits.
